(19) United States
(12) Patent Application Publication
(10) Pub. No.: US 2015/0108135 A1
(43) Pub. Date: Apr. 23, 2015

(54) DISPOSABLE COMPONENTS FOR A SPRAY GUN

(71) Applicants: FADI HANNA, SANTA CLARITA, CA (US); HENIN HANNA, SANTA CLARITA, CA (US)

(72) Inventors: FADI HANNA, SANTA CLARITA, CA (US); HENIN HANNA, SANTA CLARITA, CA (US)

(21) Appl. No.: 14/056,914

(22) Filed: Oct. 17, 2013

(51) Int. Cl. B05B 11/00

(52) U.S. Cl. CPC B05B 11/0037
USPC 220/495.06

(57) ABSTRACT

The disposable components for a spray gun include a thin, flaccid cup liner, a sleeve that installs between the upper portion of the liner and the upper portion of the cup, and a lid. The liner, sleeve, and lid include cooperating fittings for locking these components together to assure that the assembly remains sealed. A locking pin is also provided, which is installed through the rim of the lid and the rim of the liner to prevent the inadvertent disassembly of the liner and cup from the lid. A cap is also provided to seal the opening in the top of the lid when the cup and lid assembly has been removed from the spray gun. This stores any remaining paint or other liquid in the sealed cup, liner, and lid assembly in a liquid state for later use.

### BACKGROUND OF THE INVENTION

1. Field of the Invention

The present invention relates generally to pneumatic liquid spraying devices, and particularly to disposable components for a spray gun to obviate the need for cleanup of those components.

2. Description of the Related Art

The development of the pneumatic spray gun for applying paints and other liquids has proven to be a great timesaver in many fields. However, such spray guns universally comprise a number of parts, most of which are subject to contact with the paint or other liquid being applied by the spray gun. This necessitates the cleanup of all of these components immediately after each use, before the paint or other liquid can set and cure. If this is allowed to happen, a best case scenario is that the part will require considerably more time and effort to clean, and the possibility that the part will have to be discarded.

As a result, a number of disposable liners and other components have been developed for different types of spray guns to reduce the time and effort required for post-use cleanup. Most of these components comprise only a liner for the cup that contains the liquid to be sprayed. While this obviates the need to clean the cup after using the spray gun, it does nothing to obviate the need to clean the inside of the lid or top of the cup. Moreover, most such liners and other disposable components provide little or nothing to assure that the various components, and particularly the lid and cup, remain securely assembled to one another during the spraying operation. Obviously if the cup becomes loosened from the lid, a major spill will occur, which will entail the resulting need for a major cleanup and the corresponding time and expense required for the cleanup.

Thus, disposable components for a spray gun solving the aforementioned problems are desired.

### SUMMARY OF THE INVENTION

The disposable components for a spray gun comprise a thin, flaccid plastic liner for the liquid containing cup, a rigid sleeve that installs between the upper portion of the cup and the upper portion of the liner, and a cup lid that also serves to secure the cup, liner, and sleeve assembly to the spray gun. A disposable cap is also provided for sealing the outlet at the top of the lid when the lid and cup assembly are removed from the spray gun in order to preserve any remaining liquid (paint, etc.) within the spray gun cup.

The liner is provided with a plurality of passages in its rim. The passages align with corresponding pins extending upward from the rim of the sleeve. The lid is provided with corresponding passages in its rim, each of the passages having a circumferentially oriented slot extending therefrom. The liner is initially installed in the sleeve, so that the rim of the liner is seated over the rim of the sleeve and the holes in the liner rim fit over the pins of the sleeve rim. The liner and sleeve assembly are then placed in the cup, and the liquid to be sprayed is poured into the liner. The lid is then installed atop the liner, sleeve, and cup assembly, and rotated slightly to position the larger diameter heads of the pins extending from the rim sleeve over the narrower widths of the slots of the cup lid. A locking pin is also provided for installation in the exposed passage of the cup lid to prevent the lid from backing away from its installed position and allowing the cup, liner, and sleeve assembly to disassemble from the lid.

These and other features of the present invention will become readily apparent upon further review of the following specification and drawings.

### BRIEF DESCRIPTION OF THE DRAWINGS

FIG. 1 is an environmental exploded perspective view of a spray gun assembly incorporating the disposable components for a spray gun according to the present invention.

FIG. 2 is a bottom perspective view of the disposable lid member of the disposable components for a spray gun according to the present invention, illustrating various details thereof.

FIG. 3 is a perspective view of the disposable sleeve member of the disposable components for a spray gun according to the present invention, illustrating various details thereof.

FIG. 4 is an environmental elevation view in section, illustrating the assembly of a spray gun paint cup with the disposable components for a spray gun according to the present invention.

FIG. 5 is an exploded, broken away perspective view of portions of the disposable components for a spray gun according to the present invention, illustrating the system for locking the components together.

FIG. 6 is a detailed elevation view in section through the rim of the assembled components of FIG. 5, further illustrating the locking system.

Similar reference characters denote corresponding features consistently throughout the attached drawings.

### DETAILED DESCRIPTION OF THE PREFERRED EMBODIMENTS

The disposable components for a spray gun comprise a kit of economically formed and economically disposable components that preclude liquid contact with the interior of the spray gun cup when the spray gun and components are used. This greatly reduces the time and effort required for cleanup after a spraying operation, particularly in the case of spray painting, which entails many chemically complex paint formulas.

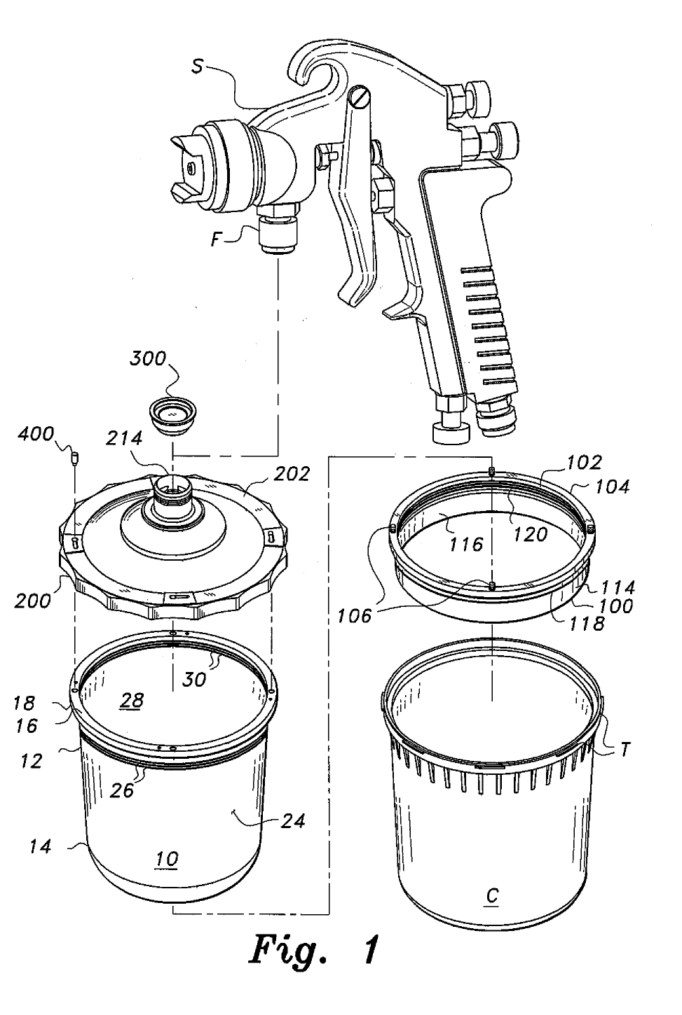

FIG. 1 of the drawings provides an exploded perspective view of the various disposable components and their assembly with a spray gun S and spray gun cup C. The illustrated spray gun S is a suction type gun, i.e., having the attachment fitting F for the lid or top of the spray gun cup or container depending below the gun. A cooperating fitting on the top of the cup lid is removably attached (e.g., threaded attachment, etc.) to the spray gun fitting F. However, the disposable components of the present invention may be adapted for use with spray guns using other principles of operation.

The disposable components comprise an economically disposable cup liner 10, an economically disposable sleeve 100 configured to fit within the upper portion of the spray gun cup C so that the cup liner 10 is installed in the sleeve 100, and an economically disposable cup lid 200 that installs over the rims of the cup C, the sleeve 100, and the liner 10 for use. An economically disposable cap 300 may also be provided to seal the opening in the top of the lid 200 to preserve any remaining liquids (e.g., paint) remaining after a spray operation. Also, an economically disposable locking pin 400 is provided for removable installation in the rim of the lid 200 to preclude inadvertent disassembly of the cup C, liner 10, and sleeve 100 from the lid 200 during use. The structure and function of each of these components is described in detail below.

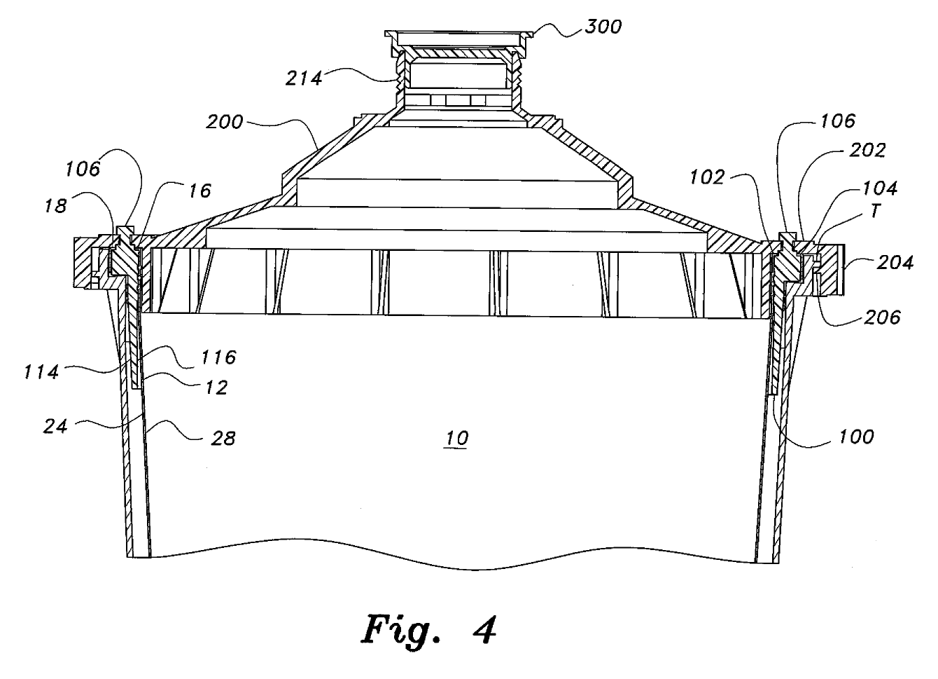

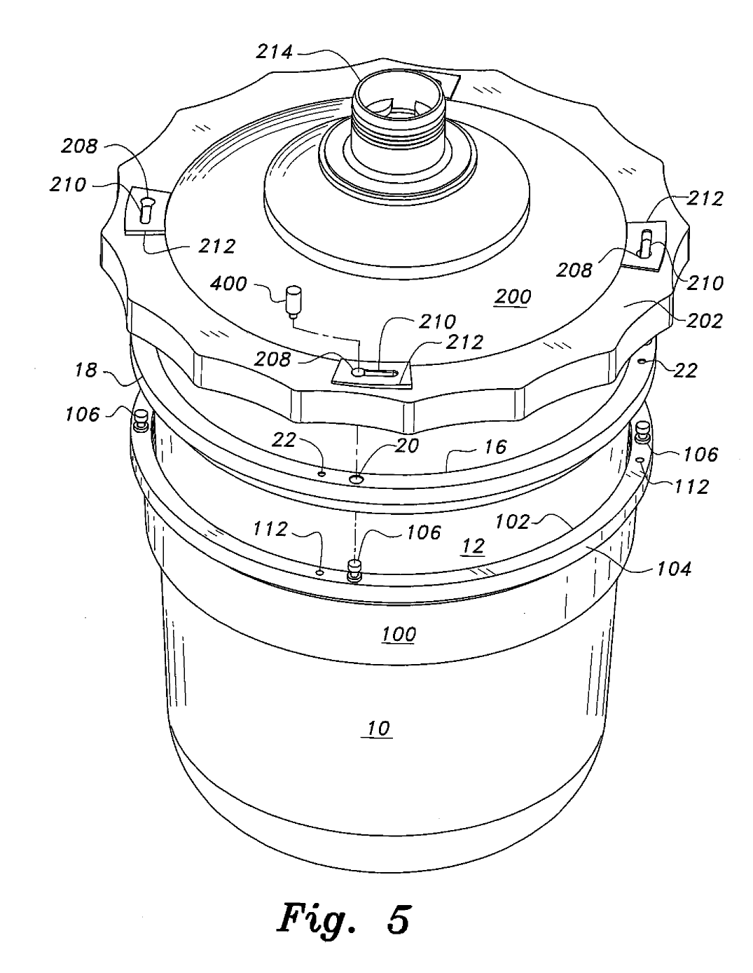

The cup liner 10 is formed of a thin, flaccid sheet of plastic material and has an open upper portion 12 and an opposite closed lower portion 14. The upper portion 12 has an upper edge 16 having an outwardly extending peripheral flange 18 that fits over the mating rim of the sleeve 100 when assembled therewith. FIGS. 4, 5, and 6 provide more detailed views of the upper portion 12 of the cup liner 10.

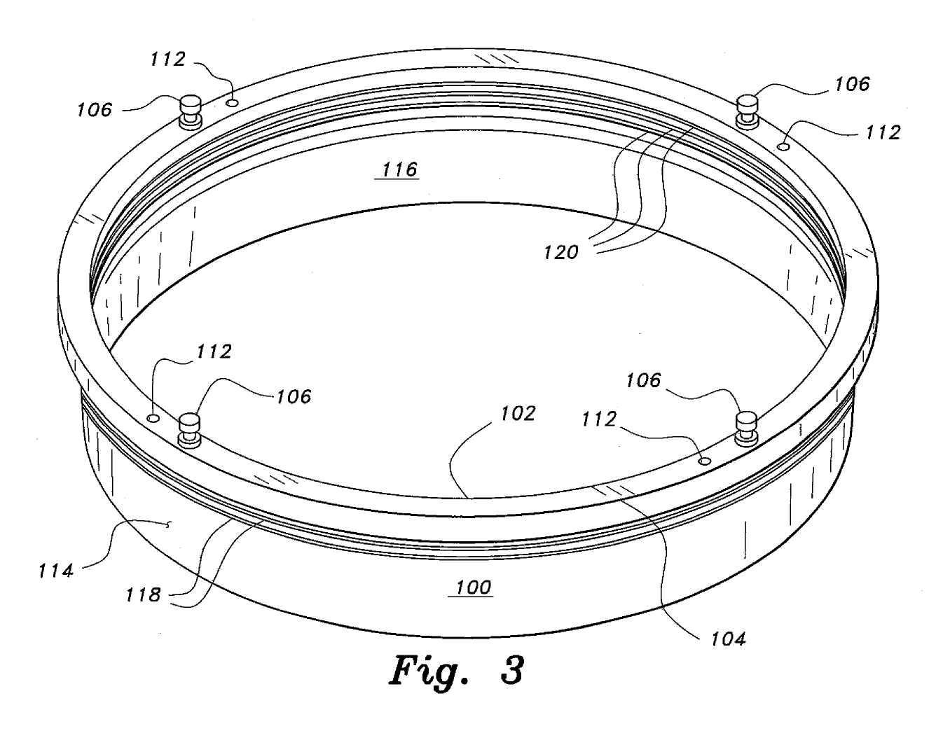

The sleeve 100 is formed as a thin, rigid component of economically disposable materials, e.g., plastic or the like. The sleeve 100 is relatively short, i.e., having a depth subtending only the upper portion 12 of the cup liner 10 or a part of the upper portion 12 when the sleeve 100 and cup liner 10 are assembled with one another. The sleeve 100 has an upper edge 102 having a peripheral flange 104 extending outwardly therefrom, substantially similar to the upper edge 16 and flange 18 of the cup liner 10. These details are illustrated in FIGS. 3, 4, and 5 of the drawings. However, the flange 104 of the sleeve 100 is slightly wider than the flange 18 of the cup liner 10, and the depending edge or skirt of the sleeve flange 104 extends to the outside of the corresponding component of the cup liner 10 when the sleeve 100 is installed about the upper portion 12 of the cup liner 10. This configuration secures the flaccid upper edge 16 and flange 18 of the cup liner 10 to fit properly between the upper rim of the cup C and the rim of the lid 200, due to the relatively rigid nature of the sleeve 100. Both the cup liner flange 18 and the sleeve flange 104 have outer depending skirts that extend for a short distance below the outer edges of their respective flanges.

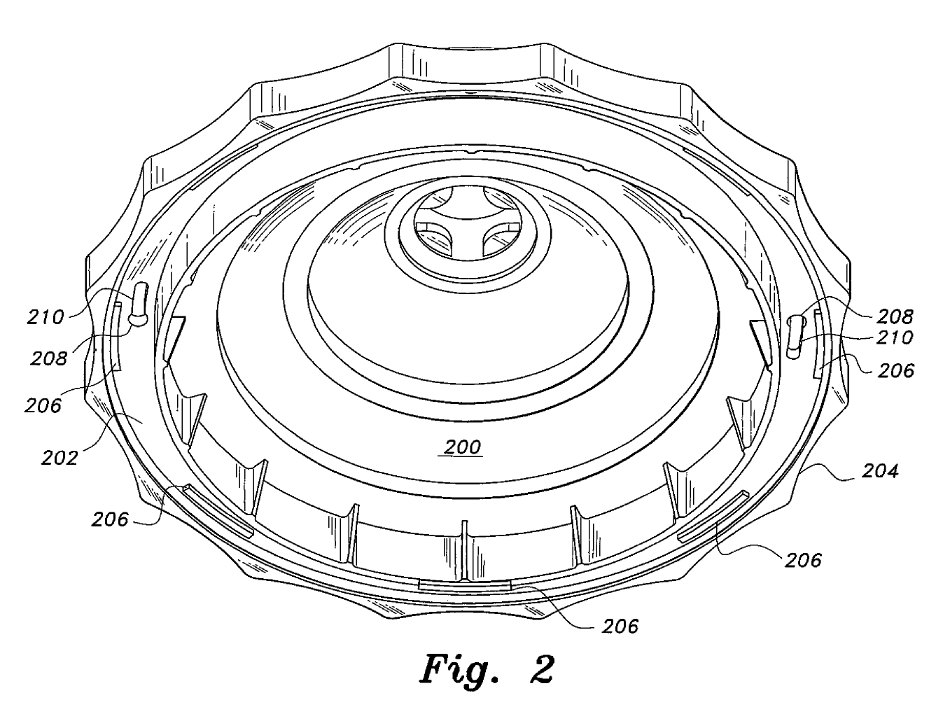

The lid 200 is formed as a rigid component of suitable plastic or other economically disposable material. Details of the lid 200 are shown in FIGS. 2, 4, 5, and 6. The lid 200 includes an outer flange 202 and a short depending skirt 204 having a plurality of semicircumferential segments 206 disposed upon the inner surface thereof, which serve as threads to secure the lid 200 to the upper rim of the cup C by means of the cooperating segmented threads T disposed about the outer edge of the upper rim of the cup C. Securing the cup lid 200 to the upper edge or rim of the cup C by means of the cooperating cup thread segments T and lid thread segments 206 clamps the cup liner flange 18 and the sleeve flange 104 between the upper edge of the cup C and the outer flange 202 of the cup lid 200, thereby capturing and sealing the sleeve flange 104 and the cup liner flange 18 between the lid 200 and the cup C when assembled therewith.

The disposable components for a spray gun include means for positively locking the lid 200 to the upper edge or rim 102 of the sleeve 110 and to the upper edge or rim 16 of the liner 10 when these components are assembled with one another. The flange 202 of the lid 200 includes a plurality of attachment pin passages 208 therethrough. Each of the passages 208 has a short, semicircumferential slot 210 extending therefrom. The widths of the slots 210 are slightly less than the diameters of the attachment pin passages 208. The cup liner flange 18 also includes a plurality of attachment pin passages 20 therethrough. The corresponding attachment pin passages 20 of the cup liner flange 18 and the passages 208 of the lid flange 202 align with one another when the cup liner 10 and lid 200 are assembled with one another.

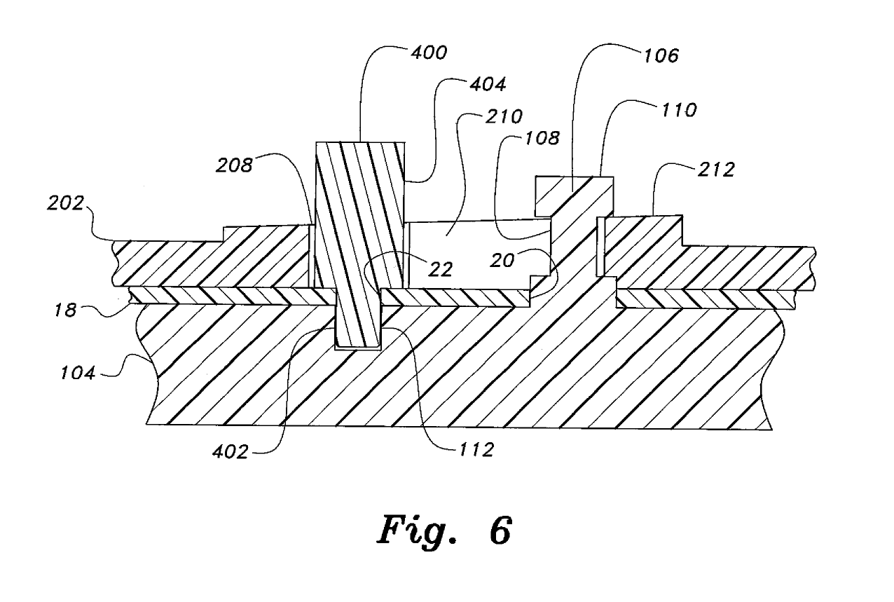

The flange 104 of the sleeve 100 includes a plurality of attachment pins 106 extending upward therefrom. The pins 106 correspond in position and number with the passages 20 of the cup liner flange 18 and the passages 208 of the lid flange 202 when these components are assembled with one another. Each of the pins 106 has a relatively narrow shank 108 adapted to pass through the semicircumferential slots 210 of the lid 200, and a relatively wider head 110 that can pass through the passages 20 of the cup liner flange 18 and passages 208 of the lid flange 202, but is captured above the top of the narrower slot 210 when the components are assembled with one another. This structure is shown in detail in the cross-sectional view of FIG. 6. It will also be noted that each of the attachment pin passages 208 and corresponding slots 210 of the cup lid 200 is disposed through an inclined ramp or slope 212 atop the outer flange 202, the ramps 212 being higher toward their right ends, i.e., the trailing ends when the lid 200 is rotated in a clockwise direction.

The liner 10, sleeve 100, lid 200, and cup C are assembled with one another by inserting the liner 10 into the sleeve 100 and aligning the attachment pins 106 of the sleeve to pass through the corresponding passages 20 of the liner flange 18. The assembly of the liner 10 and sleeve 100 is then placed into the cup C. The cup C, or more specifically the liner 10 within the cup C, may then be filled with liquid (paint, etc.) for the spraying operation. The lid 200 is then placed over the assembly of the liner 10, sleeve 100, and cup C, and the lid is rotated as necessary to align the attachment pin passages 208 with the corresponding attachment pins 106 protruding through the passages 20 in the liner flange 18. Thus, the only exposed surfaces within the cup C are the inner surface of the liner 10 and the inner surface of the lid 200, so that the liner 10 and the lid 200 prevent contact of the paint (or other liquid) therein with the inner surface of the cup C.

The lid 200 is then rotated clockwise to slide the larger diameter heads 110 of the attachment pins 106 over the narrower slots 210 and up the ramps 212 of the cup lid flange 202. The inclined surfaces of the ramps 212 force the lid 200 down tightly against the underlying sleeve flange 104 as the attachment pin heads 110 ride up the ramps, thereby tightly gripping the flange 18 of the liner 10 between the lid 200 and underlying sleeve flange 104. Simultaneously with the above operation, the cooperating thread segments 206 of the lid 200 and T of the cup C engage one another to clamp the lid 200 tightly to the cup C. At this point, the assembly of the cup C, liner 10, sleeve 100, and lid 200 may be removably installed upon the spray gun S by threading (or otherwise attaching, as appropriate) the spray gun attachment fitting 214 of the lid 200 to the lid attachment fitting F of the spray gun S to complete the assembly. The procedure for attaching the lid 200 to the spray gun fitting F is reversible to permit disassembly of the components.

It will be seen that it is possible for the cup lid 200 to rotate counterclockwise relative to the cup C, even with the clamping effects of the attachment pins 106 of the sleeve 100, the slots 210 and ramps 212 of the lid 200, and the cooperating thread segments 206 of the lid 200 and T of the cup C. In fact, this is the means used to disassemble the cup C, liner 10, sleeve 100, and lid 200 after the spraying operation. While it is not likely that these components would become disassembled from one another during use, it is still possible, and such disassembly would probably result in a major spill of paint or other liquid from the cup liner 10.

Accordingly, means is provided to lock at least the disposable components 10, 100, and 200 positively together. The liner flange 18 is provided with a plurality of liner lock pin passages 22, and the sleeve flange 104 is provided with a plurality of sleeve lock pin passages 112. The liner lock pin passages 22 are spaced circumferentially from the corresponding attachment pin passages 20 through the liner flange, and the sleeve lock pin passages 112 are spaced circumferentially from the corresponding attachment pins 106 of the sleeve 100 by a distance substantially equal to the lengths of the slots 210 extending from the attachment pin passages 208 of the lid flange 202. Thus, when the lid 200 is assembled with the remaining components as described further above, the lock pin passages 22 and 112 of the liner flange 18 and sleeve flange are aligned with the attachment pin passages 208 of the lid flange 202.

This permits the installation of a lock pin 400 into the attachment pin passage 208 and lock pin passages 22 and 212. The lock pin 400 has a relatively small diameter shank 402 to fit closely within the corresponding lock pin passages 22 and 212, but has a larger diameter head 404 to prevent the smaller width slot 210 of the lid flange 202 from passing around the lock pin head 404. This prevents the lid 200 from rotating counterclockwise relative to the underlying components, and the resulting disassembly. However, intentional disassembly is easily accomplished by removing the lock pin 400, so that it is then possible to rotate the lid 200 counterclockwise for disassembly.

The positive clamping and sealing of the cup liner flange 18 and the sleeve flange 104 between the lid flange 202 and the upper edge or rim of the cup C, has been described in detail further above. However, additional sealing means to prevent seepage of paint or other liquid from the liner 10 may be provided by a plurality of circumferential sealing ribs or bands disposed about the sleeve 100 and the upper portion 12 of the liner 10 adjacent the upper edges of these components. The sleeve 100 has an outer surface 114 and an opposite inner surface 116, as best seen in FIG. 3. A plurality of outer sealing ribs or bands 118 extends circumferentially about the outer surface 114 of the sleeve 100. These outer ribs 118 contact the inner surface of the cup C when assembled therewith. The opposite inner sealing ribs 120 are in contact with the outer surface of the liner 10 when the components are assembled with one another.

Similarly, the cup liner 10 has an outer surface 24 having outer sealing ribs or bands 26 extending therearound, and an opposite inner surface 28 having a corresponding plurality of inner sealing ribs or bands 30, as best seen in FIG. 1 of the drawings. The sealing ribs 26 of the liner outer surface 24 preferably interlock with the sealing ribs 120 of the inner surface 116 of the sleeve 100 when these components are assembled with one another to provide a more positive sealing effect. The opposite sealing ribs 30 of the liner inner surface 28 bear against the outer surface of the depending outer skirt 204 of the cup lid 200 when the components are assembled with one another, thereby providing further additional sealing for the assembly.

The spraying operation (paint, etc.) using the spray gun S, cup C, and disposable component assembly is conducted conventionally. When the spraying operation has been completed, the lid 200, including the assembly of disposable components and the cup C, may be removed from the spray gun fitting F as described further above. If paint (or other liquid) remains in the cup C and its liner 10 and it is desired to use that paint or liquid in the near future, the open fitting 214 in the top of the lid 200 may be closed by a cap 300 to seal the lid, cup, and liner assembly and store the contents of the cup and liner, generally as depicted in FIGS. 1 and 4 of the drawings. The cap 300 is also preferably formed of an economically disposable plastic or other suitable material. When the spraying operation is to be resumed, the cap 300 may be removed and discarded, and the lid 200 may be reconnected to the spray gun fitting F as described further above.

When the spraying operation has been completed, the lid 200 with its attached assembly of components is removed from the spray gun S, and the spray gun disassembled and cleaned, as is conventional in such operations. The lid 200 is removed from the cup C by withdrawing and discarding the lock pin 400, and turning the lid 200 counterclockwise from the cup C through a fraction of a turn. The lid 200 may then be discarded, and any remaining paint (or other liquid) returned to a suitable container for storage and potential future use. The now empty liner 10 and its support sleeve 100 are discarded, leaving the cup C in a clean condition to obviate the need for additional time and effort in cleanup after the spraying operation.

It is to be understood that the present invention is not limited to the embodiments described above, but encompasses any and all embodiments within the scope of the following claims.

We claim:

1. A kit of disposable components for a spray gun and cup, comprising:
a thin, flaccid, economically disposable cup liner having an upper portion and an upper edge, the upper edge having a peripheral flange extending outwardly therefrom, and a lower portion;
a thin, rigid, economically disposable sleeve, the sleeve having an upper edge and a peripheral flange extending outwardly therefrom, the cup liner fitting within the sleeve and the flange of the cup liner fitting over the flange of the sleeve when the cup liner is assembled with the sleeve, the sleeve subtending only the upper portion of the cup liner when assembled therewith; and
a rigid, economically disposable lid, the lid being adapted for removable installation to the cup, the lid capturing and sealing the flange of the sleeve and the flange of the liner between the lid and the cup when assembled therewith.

2. The kit of disposable components for a spray gun and cup according to claim 1, wherein:
the flange of the cup liner has a plurality of attachment pin passages disposed therethrough;
the sleeve has a plurality of attachment pins extending upward from the flange thereof, each of the attachment pins having a shank and a head, the head having a larger diameter than the shank, the attachment pins protruding through the attachment pin passages of the cup liner flange when the cup liner is assembled with the sleeve; and
the lid has a peripheral flange, the flange of the lid having a plurality of passages therethrough, each of the passages of the flange of the lid having a circumferentially oriented slot extending therefrom, the shanks of the attachment pins being disposed within the slots and the heads of the attachment pins capturing the flange of the lid thereunder when assembled therewith.

3. The kit of disposable components for a spray gun and cup according to claim 2, wherein the flange of the cup liner has a plurality of liner lock pin passages disposed therethrough, each of the liner lock pin passages being adjacent to a corresponding one of the attachment pin passages, and the flange of the sleeve has a plurality of sleeve lock pin passages disposed therethrough, each of the sleeve lock pin passages being adjacent to a corresponding one of the attachment pins, the kit further comprising a lock pin removably installed within one of the passages of the lid, a corresponding one of the liner lock pin passages, and a corresponding one of the sleeve lock pin passages when the cup, the cup liner, the sleeve, and the lid are assembled to one another, the lock pin precluding disassembly of the lid from the remaining components when installed therewith.

4. The kit of disposable components for a spray gun and cup according to claim 1, further comprising a reusable spray gun assembly having a cup lid attachment fitting disposed thereon, the lid having a central spray gun attachment fitting disposed thereon, the spray gun attachment fitting of the lid being removably attachable to the cup lid attachment fitting of the spray gun.

5. The kit of disposable components for a spray gun and cup according to claim 4, further comprising a cap removably attached to the spray gun attachment fitting of the lid, the cap sealing the lid when installed thereon.

6. The kit of disposable components for a spray gun and cup according to claim 1, wherein the cup liner has an inner surface and an outer surface opposite the inner surface, at least one circumferential sealing rib disposed about the inner surface of the cup liner adjacent the upper edge thereof, and at least one circumferential sealing rib disposed about the outer surface of the cup liner adjacent the upper edge thereof.

7. The kit of disposable components for a spray gun and cup according to claim 1, wherein the sleeve has an inner surface and an outer surface opposite the inner surface, at least one circumferential sealing rib disposed about the inner surface of the sleeve adjacent the upper edge thereof, and at least one circumferential sealing rib disposed about the outer surface of the sleeve adjacent the upper edge thereof.

8. A kit of disposable components for a spray gun and cup, comprising:
an economically disposable cup liner having an upper portion and an upper edge, the upper edge having a peripheral flange extending outwardly therefrom, the flange having a plurality of attachment pin passages disposed therethrough;
an economically disposable sleeve, the sleeve having an upper edge and a peripheral flange extending outwardly therefrom;
a plurality of attachment pins extending upward from the flange of the sleeve, each of the attachment pins having a shank and a head, the head having a larger diameter than the shank, the cup liner fitting within the sleeve, the flange of the cup liner fitting over the flange of the sleeve, and the attachment pins protruding through the attachment pin passages of the cup liner flange when the cup liner is assembled with the sleeve; and
an economically disposable lid, the lid having a peripheral flange, the flange having a plurality of passages therethrough, each of the passages having a circumferentially oriented slot extending therefrom, the lid being adapted for removable installation to the cup, the shanks of the attachment pins being disposed within the slots and the heads of the attachment pins capturing the flange of the lid thereunder and the lid capturing and sealing the flange of the sleeve and the flange of the liner between the lid and the cup when assembled therewith.

9. The kit of disposable components for a spray gun and cup according to claim 8, wherein:
the cup liner comprises a thin, flaccid plastic component having a lower portion;
the sleeve comprises a thin, rigid component, the sleeve subtending only the upper portion of the cup liner when assembled therewith; and
the lid comprises a rigid component.

10. The kit of disposable components for a spray gun and cup according to claim 8, further comprising a reusable spray gun assembly having a cup lid attachment fitting disposed thereon, the lid having a central spray gun attachment fitting disposed thereon, the spray gun attachment fitting of the lid being removably attachable to the cup lid attachment fitting of the spray gun.

11. The kit of disposable components for a spray gun and cup according to claim 10, further comprising a cap removably attachable to the spray gun attachment fitting of the lid, the cap sealing the lid when installed thereon.

12. The kit of disposable components for a spray gun and cup according to claim 8, wherein the flange of the cup liner has a plurality of liner lock pin passages disposed therethrough, each of the liner lock pin passages being adjacent to a corresponding one of the attachment pin passages, and the flange of the sleeve has a plurality of sleeve lock pin passages disposed therethrough, each of the sleeve lock pin passages being adjacent to a corresponding one of the attachment pins, the kit further comprising a lock pin removably installed within one of the passages of the lid, a corresponding one of the liner lock pin passages, and a corresponding one of the sleeve lock pin passages when the cup, the cup liner, the sleeve, and the lid are assembled to one another, the lock pin precluding disassembly of the lid from the remaining components when installed therewith.

13. The kit of disposable components for a spray gun and cup according to claim 8, wherein the cup liner has:
an inner surface and an outer surface opposite the inner surface;
at least one circumferential sealing rib disposed about the inner surface of the cup liner, adjacent the upper edge thereof; and
at least one circumferential sealing rib disposed about the outer surface of the cup liner, adjacent the upper edge thereof.

14. The kit of disposable components for a spray gun and cup according to claim 8, wherein the sleeve has:
an inner surface and an outer surface opposite the inner surface;
at least one circumferential sealing rib disposed about the inner surface of the sleeve, adjacent the upper edge thereof; and
at least one circumferential sealing rib disposed about the outer surface of the sleeve, adjacent the upper edge thereof.

15. A spray gun and cup and a kit of disposable components therefor, comprising in combination:
a reusable spray gun assembly having a cup lid attachment fitting disposed thereon;
an economically disposable cup liner having an upper portion with an upper edge, the upper edge having a peripheral flange extending outwardly therefrom, and a lower portion;
an economically disposable sleeve, the sleeve having an upper edge and a peripheral flange extending outwardly therefrom, the cup liner fitting within the sleeve and the flange of the cup liner fitting over the flange of the sleeve when the cup liner is assembled with the sleeve, the sleeve subtending only the upper portion of the cup liner when assembled therewith; and
an economically disposable lid having a central spray gun attachment fitting disposed thereon, the spray gun attachment fitting of the lid being removably attachable to the cup lid attachment fitting of the spray gun, the lid being removably attached to the cup, the lid capturing and sealing the flange of the sleeve and the flange of the liner between the lid and the cup when assembled therewith.

16. The spray gun and cup and kit of disposable components combination according to claim 15, wherein:
the cup liner comprises a thin, flaccid plastic component having a lower portion;
the sleeve comprises a thin, rigid component, the sleeve subtending only the upper portion of the cup liner when assembled therewith; and
the lid comprises a rigid component.

17. The spray gun and cup and kit of disposable components combination according to claim 15, wherein:
the flange of the cup liner has a plurality of attachment pin passages disposed therethrough;
the sleeve has a plurality of attachment pins extending upward from the flange of the sleeve, each of the attachment pins having a shank and a head, the head having a larger diameter than the shank, the attachment pins protruding through the attachment pin passages of the cup liner flange when the cup liner is assembled with the sleeve; and
the lid has a peripheral flange, the flange of the lid having a plurality of passages therethrough, each of the passages of the flange of the lid having a circumferentially oriented slot extending therefrom, the shanks of the attachment pins being disposed within the slots and the heads of the attachment pins capturing the flange of the lid thereunder when assembled therewith.

18. The spray gun and cup and kit of disposable components combination according to claim 17, wherein the flange of the cup liner has a plurality of liner lock pin passages disposed therethrough, each of the liner lock pin passages being adjacent to a corresponding one of the attachment pin passages, and the flange of the sleeve has a plurality of sleeve lock pin passages disposed therethrough, each of the sleeve lock pin passages being adjacent to a corresponding one of the attachment pins, the kit further comprising a lock pin removably installed within one of the passages of the lid, a corresponding one of the liner lock pin passages, and a corresponding one of the sleeve lock pin passages when the cup, the cup liner, the sleeve, and the lid are assembled to one another, the lock pin precluding disassembly of the lid from the remaining components when installed therewith.

19. The spray gun and cup and kit of disposable components combination according to claim 15, further comprising a cap removably attachable to the spray gun attachment fitting of the lid, the cap sealing the lid when installed thereon.

20. The spray gun and cup and kit of disposable components combination according to claim 15, wherein:
the cup liner has:
an inner surface and an outer surface opposite the inner surface;
at least one circumferential sealing rib disposed about the inner surface of the cup liner adjacent the upper edge thereof;
at least one circumferential sealing rib disposed about the outer surface of the cup liner adjacent the upper edge thereof; and
the sleeve has:
an inner surface and an outer surface opposite the inner surface;
at least one circumferential sealing rib disposed about the inner surface of the sleeve adjacent the upper edge thereof; and
at least one circumferential sealing rib disposed about the outer surface of the sleeve adjacent the upper edge thereof.
